(19) United States
(12) Patent Application Publication
(10) Pub. No.: US 2012/0151352 A1
(43) Pub. Date: Jun. 14, 2012

(54) RENDERING SYSTEM COMPONENTS ON A MONITORING TOOL

(76) Inventors: RAMPRASAD S., Bangalore (IN); Srilatha M., Ramadugu (IN); Dinesh Rao, Bangalore (IN); Suhas S., Bangalore (IN); Raina Saboo, Bangalore (IN); M. Sireesha, Proddatur (IN)

(21) Appl. No.: 12/963,645

(22) Filed: Dec. 9, 2010

(51) Int. Cl. G06F 3/048

(52) U.S. Cl. 715/734

(57) ABSTRACT

Various embodiments of systems and methods for rendering system components on a monitoring tool are described herein. A method includes receiving a user selection of a system from a list of monitorable systems, retrieving a plurality of components of the system selected by the user, and generating a graphical display illustrating the plurality of components in a hierarchical topology. Each component is being represented by a graphical indicator. The graphical indicator displays critical information or problem(s) related to a component that can be instantly perceived by the user. Further, the hierarchical topology illustrating a relationship (connectivity) between the components enables the user to easily track a root cause of the problem related to the component.

### FIELD

The technical field relates generally to a computer system, and more particularly to rendering the computer system components on a monitoring tool.

### BACKGROUND

System landscape of various organizations includes one or more computer systems that are monitored and maintained by a system administrator. A computer system typically includes a plurality of components. Usually, the computer system includes a hardware component (e.g., a host) and one or more software components (e.g., a database, an application instance, etc) that runs (executes) on the hardware component. The system administrator monitors the plurality of components of the system on a monitoring tool (e.g., SAP® solution manager).

Each component of the system is monitored or observed based upon one or more metrics. If a value of the metric is above a predefined threshold an alert is triggered for the component or a problem is indicated. Essentially, the system administrator analyzes the metrics, included or listed under the component, to investigate a number of alerts triggered for the component or to investigate if the component has any problem. The problem may belong to various categories, e.g., availability, configuration, exception, and performance of the component. Usually, the system administrator also analyzes the metrics to investigate the category to which the problem belongs to. Sometimes, the problem in the component may be due to a problem in other component(s) associated with it. Therefore, the administrator may also have to determine/investigate other components to analyze a root cause of the problem.

However, it might be inconvenient for the administrator to drill down to the metrics to investigate if the component has a problem. Further, it may be troublesome and time consuming to analyze all the metrics of the component to determine the category having the problem and/or to determine the number of alerts triggered for the component. Additionally, it may be difficult to determine and investigate the other components, associated with the component (the one having the problem), to analyze the root cause of the problem.

It would be desirable, therefore, to provide a system and method for rendering the system components on the monitoring tool that obviates the above mentioned problems.

### SUMMARY OF THE INVENTION

Various embodiments of systems and methods for rendering system components on a monitoring tool are described herein. In one aspect, the monitoring tool is installed on a computer system to receive a user selection of a system from a list of monitorable systems. Based upon the selection, a plurality of components of the system are retrieved. The monitoring tool generates a graphical display to illustrate the plurality of components in a hierarchical topology. In the hierarchical topology, each component is represented by a graphical indicator. The graphical indicator of each component displays critical information or problem(s) related to a corresponding component that can be easily perceived by a user. Further, the user can easily analyze a relationship or connectivity between the components, in the hierarchical topology, to track a root cause of the problem related to the component.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a system landscape including a monitoring tool for analyzing one or more monitorable system, according to an embodiment of the invention.

FIG. 2 is an exemplary screen display of various components of a monitorable system arranged in a hierarchical topology, according to an embodiment of the invention.

FIG. 3 illustrates an exemplary list of monitorable systems rendered on the monitoring tool, according to an embodiment of the invention.

FIG. 4 is an exemplary screen display of details of alerts generated when an alert icon is selected from a graphical indicator representing a component of the monitorable system, according to an embodiment of the invention.

FIG. 5 is an exemplary screen display of various subcategories generated when a category icon is selected from the graphical indicator, according to an embodiment of the invention.

FIG. 6 is an exemplary screen display of various subcategories generated when another category is selected from a category bar included on the screen display of FIG. 5.

FIG. 7 is a flow chart illustrating the steps performed to render various components of the monitorable system on a monitoring tool, according to various embodiments of the invention.

FIG. 8 is a block diagram of an exemplary computer system, according to an embodiment of the invention.

### DETAILED DESCRIPTION

Embodiments of techniques for rendering system components on a monitoring tool are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

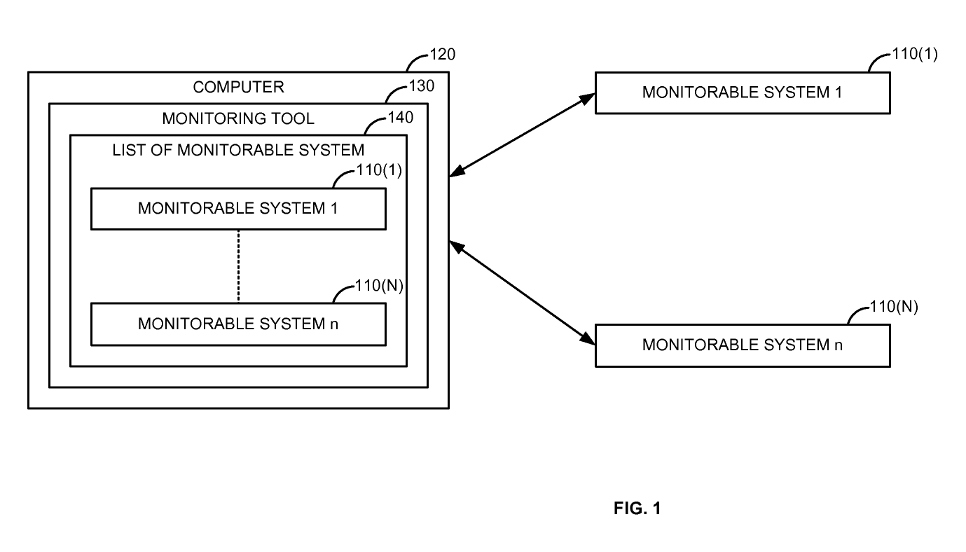

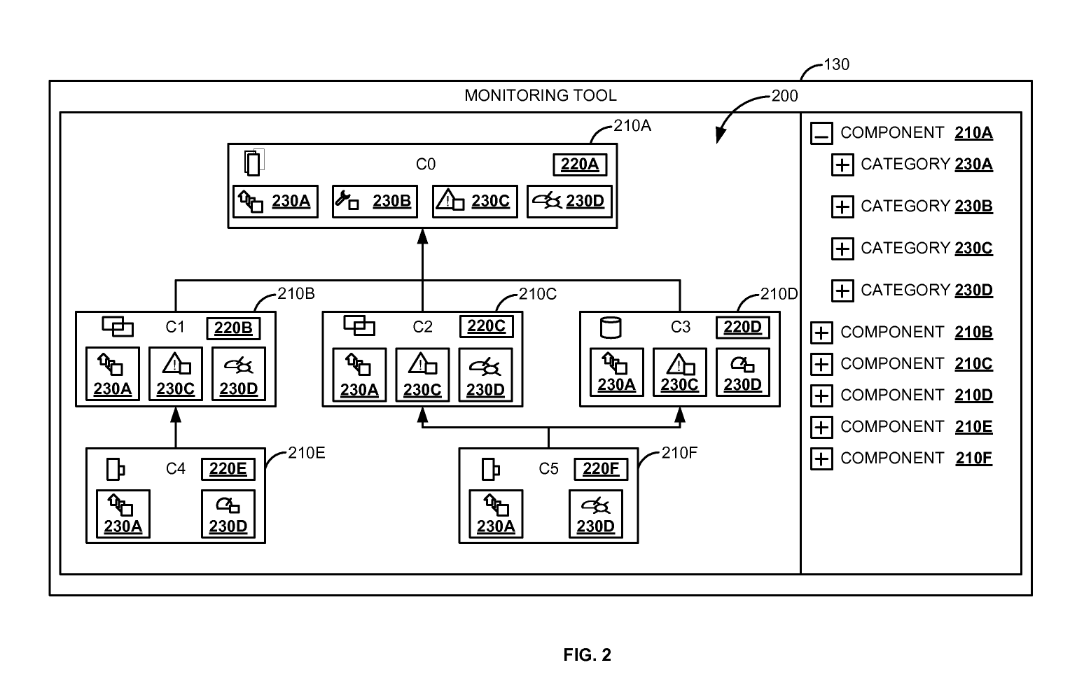

FIGS. 1-2 illustrate one embodiment of the invention for analyzing one or more monitorable systems 110 (1-n) on a monitoring tool 130 installed on a computer 120. The monitoring tool 130 displays the plurality of monitorable systems 110 (1-n) on a list 140. A user selects a system 110(1) from the list 140. A plurality of components (C0-C5) of the selected system 110(1) are retrieved. The plurality of components (C0-C5) are displayed graphically in a hierarchical topology 200 (refer to FIG. 2). In the hierarchical topology 200 each component (C0-C5) is being represented by a graphical indicator. For example, the components (C0-C5) may be represented by blocks 210 (A-F), respectively. The graphical indicators or the blocks 210 (A-F) display critical information related to the corresponding components (C0-C5) of the selected system 110(1).

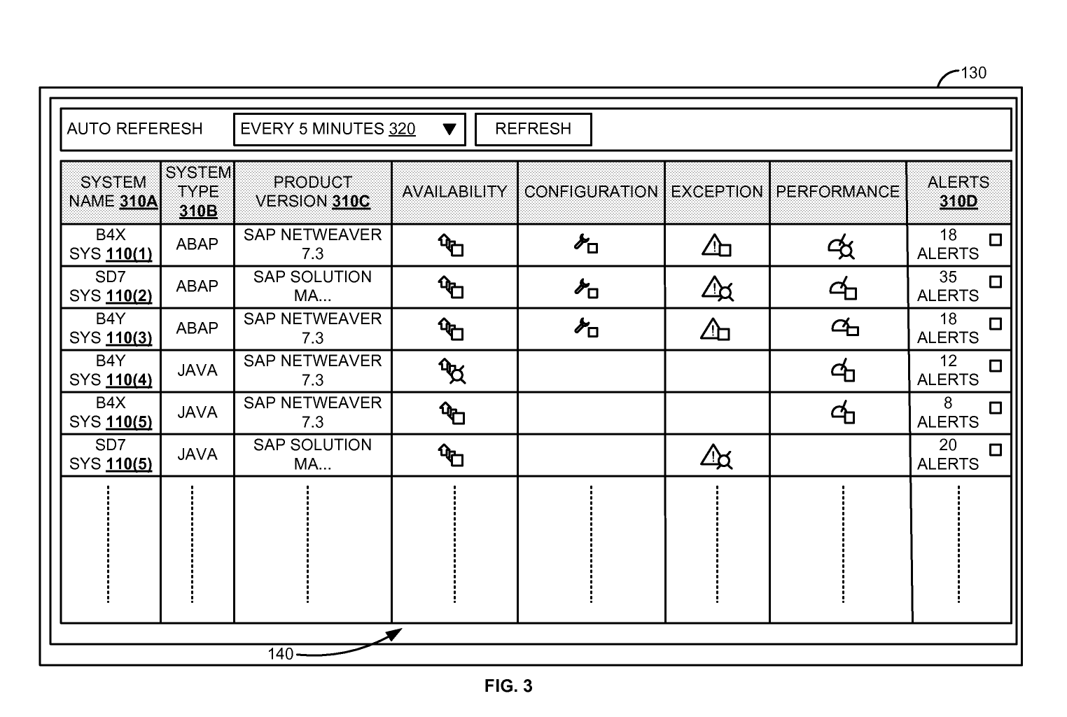

The user (e.g., a system administrator) may select the system 110(1) by analyzing the list 140. In one embodiment, the list 140 may include various fields for analysis. FIG. 3 illustrates the fields of the list 140 that can be analyzed, e.g., a name of monitorable system (i.e., system name 310A), a type of monitorable system (i.e., system type 310B), a product version of the monitorable system (i.e., product version 310C), total number of alerts triggered for the monitorable system (i.e., alerts 310D), and status related to the plurality of categories, e.g., availability, configuration, exception, and performance. In one embodiment, the user may analyze the alert 310D and the status related to the plurality of categories (availability, configuration, exception, and performance) to select the system to be monitored.

Each category may be represented by a symbol. The status of the categories (availability, configuration, exception, and performance) may be displayed by highlighting their respective symbols with a suitable color or by a specific symbol. For example, if the performance of the system 110(1) has deteriorated then the symbol indicating performance of the system 110(1) may be highlighted in ‘red’ color. The symbols may be highlighted in ‘green’ color to represent proper/satisfactory status.

The list 140 (including the status of the categories (availability, configuration, exception, and performance) and the alerts 310D) is auto updated on real time or after a specified period of time 320. The period of time may be specified by the user. The list 140 may also be updated when the user refreshes a screen of the monitoring tool 130. The fields related to the status of the categories (availability, configuration, exception, and performance) and the alerts 310D of the list 140 may be analyzed by the user to select the system to be monitored. For example, if the user is interested in monitoring the systems based on the performance then the user may select the system 110(1) as the status of the performance for the system 110(1) is critical or deteriorated (i.e., performance symbol for the system 110(1) is highlighted in ‘red’). In another embodiment, the user may randomly select any system for analysis.

Once the system 110(1) is selected, the tool 130 retrieves the plurality of components (C0-C5) of the system 110(1). The component may be a software component (e.g., an application instance, a database, etc), a hardware component (e.g., a host, etc), or a logical component (i.e., a combination of software and hardware component). For example, the component C0 is the logical component, the components (C1-C2) are the software components (application instances), the component C3 is also the software component (database), and the components (C4-C5) are the hardware components (hosts). Essentially, the software component runs on the hardware component, e.g., the software component C1 (application instance) runs on the hardware component C4 (host) while the software component C2 (application instance) and the software component C3 (database) run on the hardware component C5 (host).

The components (C0-C5) are displayed graphically in the hierarchical topology 200. Typically, the components (C0-C5) are displayed graphically, in the hierarchical topology 200, on a left hand section of the monitoring tool 130, as illustrated in FIG. 2. The hierarchical topology 200 displays a relationship between the components (C0-C5), e.g., in a tree structure. The relationship may be one of a logical, physical and functional. For example, the hierarchical topology 200 may display the logical relationship or logical connectivity between the components (C0-C5). To display the logical relationship, the logical component C0 may be considered to represent the system 110(1) that includes the software components (C1-C3) and the hardware components (C4-C5). Typically, the logical component C0 is placed at a top level of the hierarchical topology 200. The software components (C1-C3) may be placed in the next level of the hierarchical topology 200 and the hardware components (C4-C5), on which the software components (C1-C3) execute or run may be placed at a bottom level of the hierarchical topology 200, as illustrated in FIG. 2.

In the hierarchical topology 200, each component (C0-C5) may be represented by the graphical indicator. For example, the components (C0-C5) may be represented by the blocks 210 (A-F), respectively. In one embodiment, each block (graphical indicator) may include a symbol to illustrate a type of component it represents. The blocks 210 (A-F) display critical information related to the corresponding components (C0-C5). Essentially, the blocks 210 (A-F) include one or more selectable (clickable) icons to display the critical information related to the corresponding components (C0-C5).

The selectable icon may be one of an alert icon and a category icon. The blocks 210 (A-F) include the alert icons 220 (A-F), respectively. The alert icons 220 (A-F) may display a number of alerts triggered for the corresponding components C0-C5. For example, the alert icon 220A may display a numeric value ‘2’ to indicate that two alerts are triggered for the component C0. Similarly, the alert icon 220B may display the numeric value ‘3’ to indicate that three alerts are triggered for the component C1. In one embodiment, the alert icon is auto updated on real time or after a specified period of time.

If the user selects the alert icon, the details related to one or more alerts, triggered for the corresponding component, is rendered on the monitoring tool 130. For example, if the user selects the alert icon 220A, the details related to one or more alerts (e.g., two alerts) triggered for the component C0 is rendered on the monitoring tool 130. Similarly, if the user selects the alert icon 220B, the details related to one or more alerts (e.g., three alerts) triggered for the component C1 is rendered on the monitoring tool 130. Essentially, the details related to the alerts are rendered in a new window.

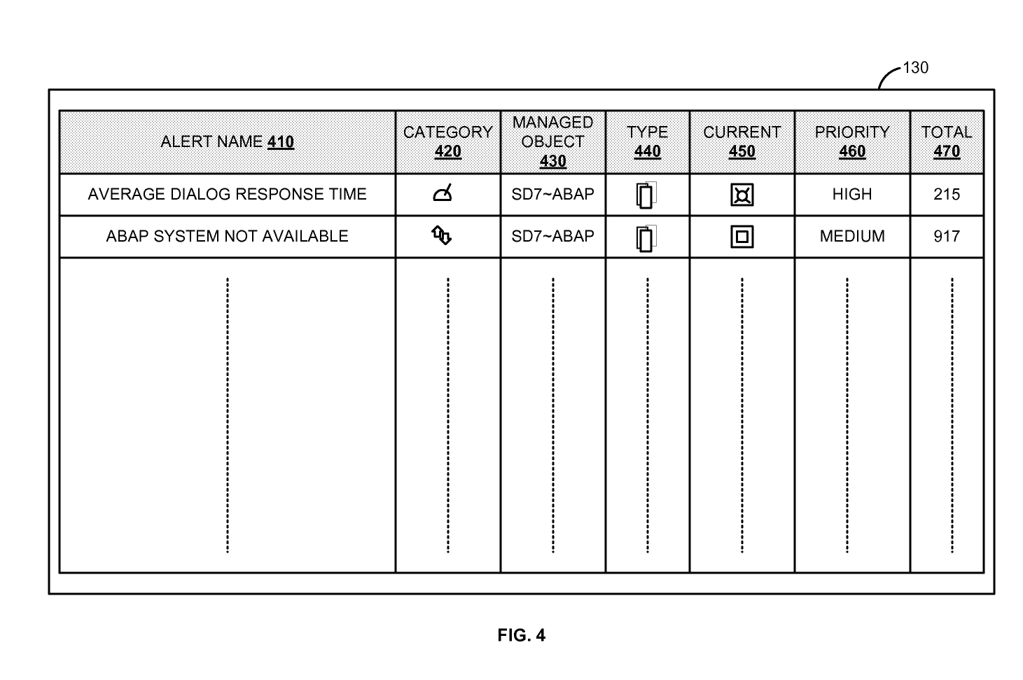

In one embodiment, as illustrated in FIG. 4, the details related to the alert may include at least one of a name of alert (i.e., alert name 410), category to which the alert is related to (i.e., category 420), name of the component for which the alert is triggered (i.e., object name 430), type of component for which the alert is triggered (i.e., type 440), current status of the alert (i.e., current 450), priority of the alert (i.e., priority 460), total number of times the alert has been triggered (i.e., total 470).

The blocks 210 (A-F) may also include one or more category icons 230 (A-D). The category icons 230 (A-D) display the status of the categories availability, configuration, exception, and performance, respectively. For example, the block 210A includes the category icons 230 (A-D) to display the status of the categories, i.e., availability, configuration, exception, and performance, respectively, related to the component C0 and the blocks 210 (B-D) include the category icons 230(A, C, and D) to display the status of the categories, i.e., availability, exception, and performance, respectively, related to the components (C1-C3). The blocks 210 (B-D) may not include the category icon 230B (i.e., configuration) as the configuration may not be a relevant category for the software components (C1-C3). The blocks 210 (E-F) include the category icons 230A and 230D to display the status of the categories, i.e., the availability and performance, respectively, related to the components (C4-C5). The blocks 210 (E-F) may not include the category icons 230B (i.e., configuration) and 230C (i.e., exception) as the configuration and exception may not be relevant category for the hardware components or the hosts (C4-C5).

The category icons 230 (A-D) may include the symbol of the corresponding category. For example, the category icon 230A includes the symbol of availability, the category icon 230B includes the symbol of configuration, the category icon 230C includes the symbol of exception, and the category icon 230D includes the symbol of performance, as illustrated in FIG. 2. The status of the category may be represented by highlighting the symbol with a suitable color. For example, if the status of performance for the component C0 is critical, the symbol of performance inside the category icon 230D of the block 210A may be highlighted in ‘red’. A glance at the block 210A instantly indicates that the status of performance of the component C0 is critical and requires attention.

The status of the performance of the component C0 may be critical due to its own configuration and/or due to performance issues in the components (C1-C5) that are positioned below the component C0 in the hierarchical topology 200. Usually, the component C0 (positioned at higher hierarchy level) has performance issues because of some performance issues in one or more components (C1-C5) that are positioned in a lower hierarchy level than the component C0. The user may track from the top to the bottom hierarchical level, one by one, to determine a root cause of the problem (e.g., the performance issues).

Essentially, the user starts with the component C0, having performance issues, and then track the components (C1-C3) that are directly connected to the component C0 and positioned immediately below the component C0 in the hierarchical topology 200. The user may trace that the component C3 does not have any performance issue (the symbol of performance inside the category icon 230D of the component C3 may be highlighted in color ‘green’ (not shown)) while the components (C1-C2) have performance issues (the symbol of performance inside the category icon 230D of the components C1 and C2 can be highlighted in ‘red’ color (not shown)). The user may then track the components (C1-C2) to investigate if the components (C1-C2) have performance issues due to some performance issues in the components (C4-C5) positioned immediately below the components (C1-C2) in the hierarchical topology 200. The user may trace that the component C4 connected to the component C1 does not have any performance issues (the symbol of performance inside the category icon 230D of the components C4 can be highlighted in ‘green’ to indicate this (not shown)), while the component C5 connected to the component C2 have performance issues (the symbol of performance inside the category icon 230D of the component C5 can be highlighted in ‘red’ (not shown)). Therefore, the root cause of the performance issue, of the component C0, may reside in the components C1 and C5 (lower level components).

The component C0 may also have performance issues due to its own configuration. In one embodiment, when it is analyzed that the status of performance of the component C0 is critical, the user may select (click) the category icon 230D of the block 210A (i.e., component C0) to investigate if the component C0 has performance issues due to its own configuration.

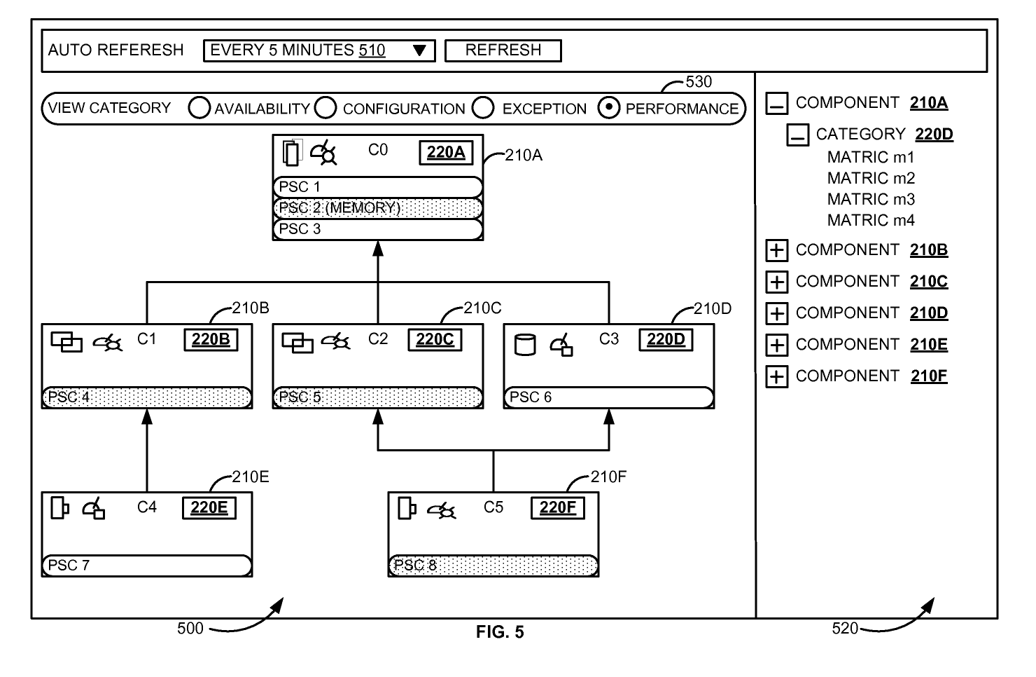

When the user selects the category icon 230D of the block 210A (i.e., component C0), a new graphical display 500 is generated on the left hand section of the monitoring tool 130 (refer to FIG. 5). The new graphical display 500 includes the block 210A (i.e., component C0) whose category icon 230D is selected and the blocks 210 (B-F) that are connected to and positioned below the block 210A in the hierarchical topology 200 (i.e., the components C1-C5). Essentially, when the user selects the category icon of any block, the new graphical display is generated that includes the block whose category icon is selected and one or more blocks that are connected to and positioned below the block whose category icon is selected.

The blocks 210 (A-F) of the new graphical display 500 include the details related to the performance category (i.e., the category of the selected category icon 230D). For example, the blocks 210 (A-F) may include one or more subcategories related to the performance category of the corresponding components (C0-C5). For example, the block 210A includes the subcategories (Psc1, Psc2, and Psc3) related to the performance of the component C0 and the blocks 210 (B-F) include the subcategories Psc4-Psc8, respectively, related to the performance of the corresponding components C1-C5, as illustrated in FIG. 5. The status of the subcategories (Psc1-Psc8) may also be displayed by highlighting the subcategories with the suitable color (e.g., if the status is critical: highlighted in ‘red’, if required attention: highlighted in ‘yellow’, and if normal: highlighted in ‘green’). In one embodiment, the status of the subcategories may be auto updated on real time or after a specified period of time 510. The period of time may be specified by the user.

The user may analyze the subcategories (Psc1-Psc8) of the new graphical display 500 to detect the root cause of the performance issues of the component C0 (the highest level component of the new graphical display 500). For example, the user may analyze the subcategories (Psc1-Psc3) of the block 210A to determine if the component C0 has performance issues due to its own configuration. Similarly, the user may analyze the subcategories (Psc4-Psc8) to determine if the performance issue of the component C0 is related to any other components (C1-C5) positioned below the component C0. Essentially, the user analyzes the status of the subcategories (Psc1-Psc8) to determine the root cause of the performance issues of the component C0. The user may analyze that the subcategories Psc2 (e.g., a memory), Psc4, Psc5, and Psc8 are highlighted in ‘red’ and that the performance issues of the component C0 is related to the subcategory Psc2 or the memory of the component C0, subcategory Psc4 of the component C1, subcategory Psc5 of the component C2, and subcategory Psc8 of the component C5.

Each subcategory (Psc1-Psc8) includes one or more metrics. The metrics of the subcategory may also be analyzed on a right hand section 520 of the monitoring tool 130 (refer to FIG. 5). Essentially, the user analyzes the metrics of the subcategory to further investigate the problem related to the subcategory. For example, the user may analyze the metrics (m1-m4) related to the subcategory (Psc2 or memory) of the component C0 to further investigate the problem related to the memory. The metrics (m1-m4) may be analyzed by analyzing a value of the metric and a status (rating) of the metric that may also be displayed on the right hand section 520 of the monitoring tool 130.

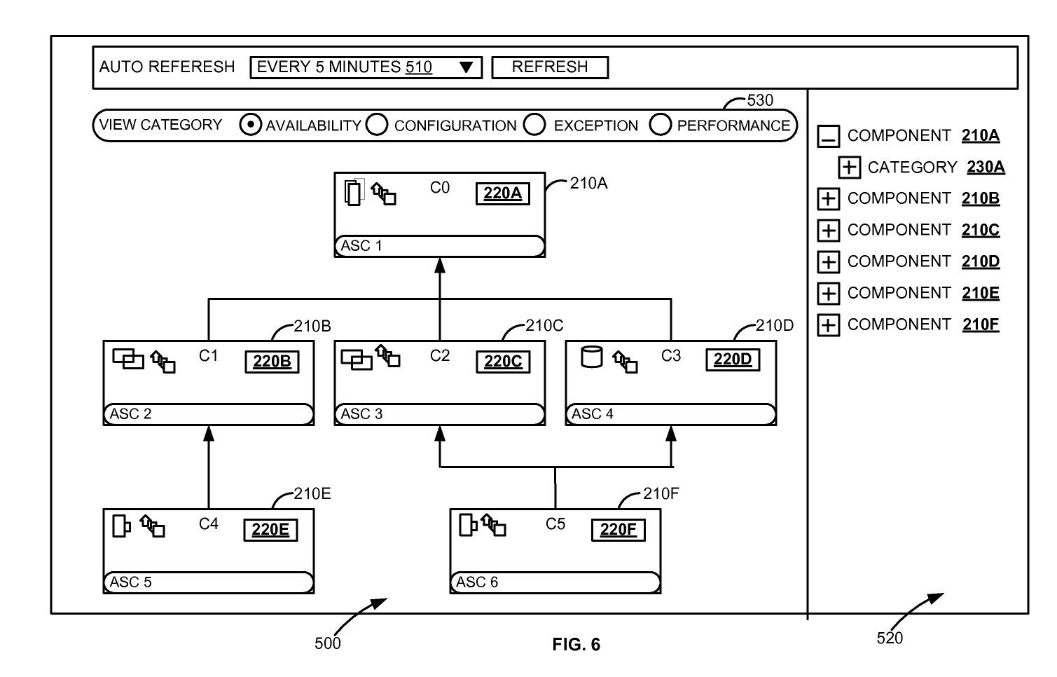

In one embodiment, the new graphical display 500 includes a category bar 530. The category bar 530 illustrates the categories namely availability, configuration, exception, and performance. The user may select the category from the categories illustrated in the category bar 530. Essentially, when the user selects the category (e.g., availability) from the category bar 530, the new graphical display 500 (illustrating the performance subcategories Psc1-Psc8) gets refreshed and the blocks 210 (A-F) of the new graphical display 500 gets updated (refreshed) with the subcategories related to the category selected by the user, i.e., availability. For example, the blocks 210 (A-F) starts displaying the subcategories Asc1-Asc6, respectively, related to the availability of the respective components C0-C5 (as illustrated in FIG. 6). Essentially, the category bar 530 is used to switch to any other category and to analyze the component 210 (A-F) of the new graphical display 500 under the selected category.

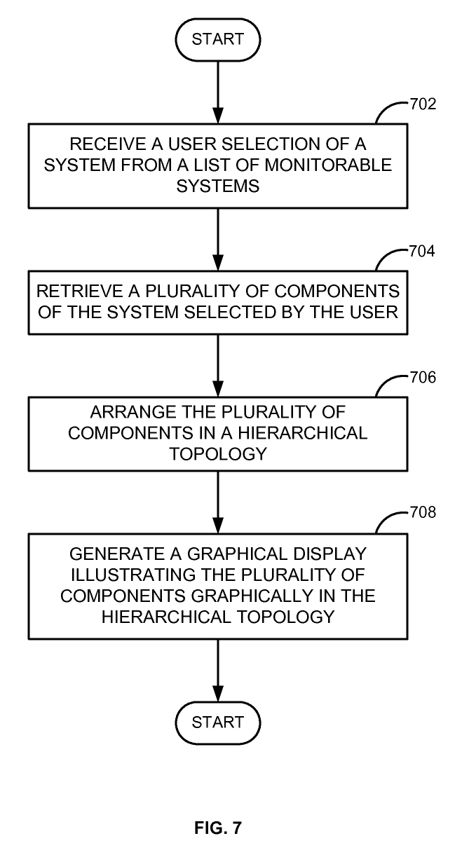

FIG. 7 is a flowchart illustrating a method for rendering the system components on the monitoring tool 130. The monitoring tool 130 displays the list 140 illustrating the plurality of monitorable systems 110 (1-n) for the user's selection. The list 140 includes the status of the categories (availability, configuration, exception, and performance) and the alerts 310D related to each of the monitorable system 110 (1-n). The user may make selection of the system 110(1) based upon the status of the category of the user's interest (e.g., performance). The monitoring tool 130 receives the user selection of the system 110(1) from the list 140 at step 702. Based upon the selection, the plurality of the components (C0-C5) of the system 110(1) is retrieved at step 704. The retrieved components (C0-C5) are arranged in the hierarchical topology 200 at step 706. The monitoring tool 130 generates the graphical display to illustrate the plurality of components (C0-C5) in the hierarchical topology 200 at step 708. In the hierarchical topology 200, each component is being represented by the graphical indicator. For example, the components (C0-C5) may be represented by the blocks 210 (A-F), respectively. The blocks 210 (A-F) display critical information related to the respective components (C0-C5) that can be easily perceived by the user.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

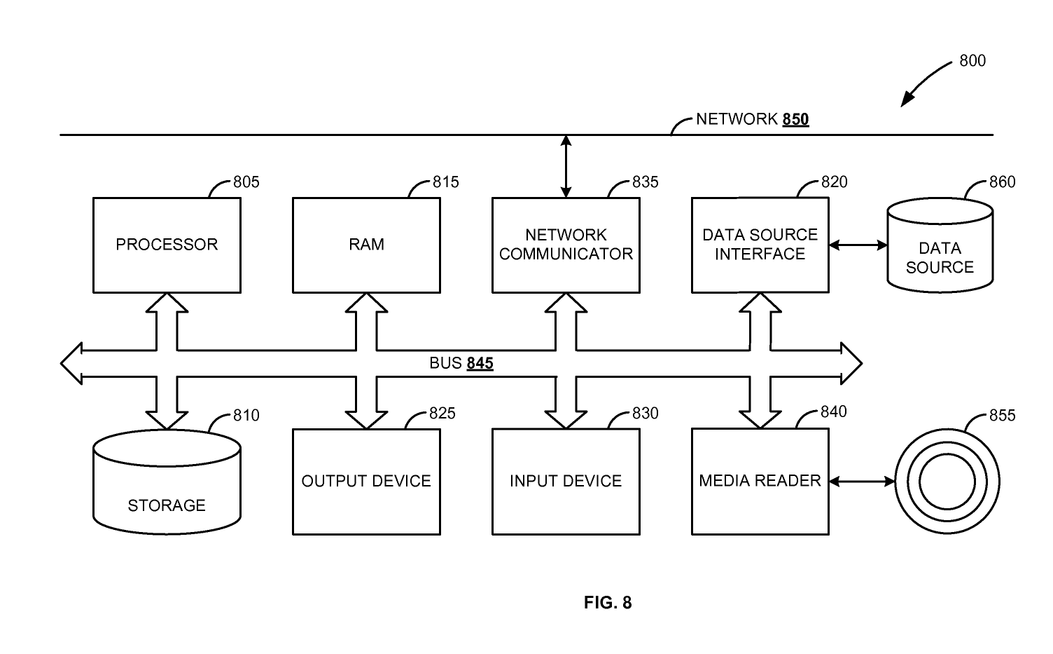

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive a user selection of a system from a list of monitorable systems, wherein the list of monitorable systems includes names, number of alerts, and status related to at least one of availability, performance, exception, and configuration for each of the monitorable systems;
based upon the selection, retrieve a plurality of components of the system; and
generate a graphical display illustrating the plurality of components in a hierarchical topology, wherein each component is represented by a graphical indicator.

2. The article of manufacture of claim 1, wherein the list of monitorable systems is auto updated after a predefined period of time.

3. The article of manufacture of claim 1, wherein the hierarchical topology displays a relationship between each component and wherein the relationship is one of a logical, physical, and functional.

4. The article of manufacture of claim 1, wherein the graphical indicator includes at least one of the following selectable icons:
an alert icon displaying a number of alerts triggered for a component; and
one or more category icons, wherein a category icon displays a status of a category associated with the component and wherein the category is one of a performance, availability, exception, and configuration.

5. The article of manufacture of claim 4, wherein the alert icon and the category icon are auto updated either on real time or after a preconfigured time interval.

6. The article of manufacture of claim 4, wherein if a user selects the alert icon then details related to one or more alerts triggered for the component, whose alert icon is selected, are rendered on the monitoring tool.

7. The article of manufacture of claim 6, wherein the details related to one or more alerts are rendered in a new window.

8. The article of manufacture of claim 6, wherein the details related to the alert comprises an alert name, priority of the alert, current status of the alert, total number of times the alert is triggered, category of the alert, name of the component for which the alert is triggered, and type of the component for which the alert is triggered.

9. The article of manufacture of claim 4, wherein if a user selects the category icon a new graphical display is generated and wherein the new graphical display comprises the component whose category icon is selected and one or more components connected to and positioned below the component whose category icon is selected.

10. The article of manufacture of claim 9, wherein one or more components of the new graphical display include at least one subcategory related to the category of the selected category icon.

11. The article of manufacture of claim 10, wherein the new graphical display includes a category bar displaying a plurality of categories and wherein if the user selects the category from the category bar the new graphical display is updated with one or more subcategories related to the category selected by the user.

12. A computerized method for rendering a plurality of components of a system on a monitoring tool, the method comprising:
receiving a user selection of the system from a list of monitorable systems;
retrieving the plurality of components of the system selected by the user; and
generating a graphical display illustrating the plurality of components in a hierarchical topology, wherein each component is represented by a graphical indicator.

13. The method of claim 12 further comprising:
displaying a number of alerts triggered for a component on an alert icon included within the graphical indicator of the component; and
displaying a status of a category related to the component on a category icon included within the graphical indicator of the component, wherein the category is one of a performance, availability, exception, and configuration of the component.

14. The method of claim 13 further comprising:
in response to selecting the alert icon, rendering details related to one or more alerts triggered for the component; and
in response to selecting the category icon, generating a new graphical display illustrating the component whose category icon is selected and one or more component connected to and positioned below the component whose category icon is selected in the hierarchical topology.

15. The method of claim 14, wherein one or more components of the new graphical display include at least one subcategory related to the category of the selected category icon.

16. A computer system for rendering a plurality of components of a system in a system landscape, comprising:
a memory to store a program code;
a processor communicatively coupled to the memory, the processor configured to execute the program code to:
receive a user selection of the system from a list of monitorable systems;
based upon the selection, retrieve the plurality of components of the system; and
generate a graphical display illustrating the plurality of components in a hierarchical topology, wherein each component is represented by a graphical indicator.

17. The computer system of claim 16, wherein each graphical indicator includes at least one of the following selectable icons:
an alert icon displaying a number of alerts triggered for a component; and
one or more category icons, wherein a category icon displays a status of a category associated with the component and wherein the category is one of a performance, availability, exception, and configuration of the component.

18. The computer system of claim 17, wherein the processor is further configured to:
in response to selecting the alert icon, render details related to one or more alerts triggered for the component on a user interface device; and
in response to selecting the category icon, generate a new graphical display comprising the component whose category icon is selected and one or more components connected to and positioned below the component whose category icon is selected in the hierarchical topology.

19. The computer system of claim 18, wherein one or more components of the new graphical display includes at least one subcategory related to the category of the selected category icon.

20. The computer system of claim 17, wherein the processor is further configured to:
update at least one of the alert icon and the category icon either on real time or after a preconfigured time interval.
